(19) United States
(12) Patent Application Publication
(10) Pub. No.: US 2006/0219612 A1
(43) Pub. Date: Oct. 5, 2006

(54) Multiport ejector for use with sorter

(75) Inventors: Klaus Michael Oestreich, Stafford, TX (US); Richard Pao-kiang Cheng, Sugar Land, TX (US)

Correspondence Address: CRAIN, CATON & JAMES, FIVE HOUSTON CENTER, 1401 MCKINNEY, 17TH FLOOR, HOUSTON, TX, 77010, US

(73) Assignee: SATAKE USA, INC., Stafford, TX (US)

(21) Appl. No.: 11/307,112

(22) Filed: Jan. 24, 2006

Related U.S. Application Data
(60) Provisional application No. 60/648,136, filed on Jan. 28, 2005.

(51) Int. Cl. B07C 5/00

(52) U.S. Cl. 209/644

(57) ABSTRACT

A non-air fluid-based ejector utilizing an actuator-port assembly for use in a sorting machine is disclosed. The ejector has at least 20 dispersion ports per inch, each dispersion port associated with a fluid chamber containing a piezoelectric crystal which dispersed fluid upon receipt of an activation signal based on predetermined criteria compared to data received from an imaging device. The ejector may comprise an array of such ports and be activated to dispense fluid sized to the specific shape characteristics of the selected product.

### CROSS-REFERENCE TO RELATED APPLICATIONS

This application claims the benefit of U.S. Provisional Patent Application Number 60/648,136 entitled, “Multiport ejector for use with sorter,” filed on Jan. 28, 2005 in the United States Patent and Trademark Office.

### STATEMENT REGARDING FEDERALLY SPONSORED RESEARCH OR DEVELOPMENT

Not Applicable.

### FIELD OF INVENTION

This invention pertains to ejectors for use with sorting machines that separate selected fungible items from standard items, the items flowing through the machine in large volumes at high rates of speed.

### BACKGROUND OF THE INVENTION

A typical sorting machine of the type envisioned for application of the present invention is a high speed sorting machine used for sorting fungible products in the food industry or otherwise. For example, individual rice grains may be sorted in a gravity-fed sorter to separate grains selected as “substandard.” In the art, the term “substandard” may apply to a grain having any undesirable characteristic, including color, shape, size or breakage, or any other characteristic not within the standard limits for acceptable standard products for a particular sorting.

Although such products may be sorted by weight, mechanical measurement size or the like, presently most commonly utilized sorting machines employ one or more optical sensors sensitive not only to black, white and shades of gray differences, but also to subtle variations in color hues. Such sensors are also capable of identifying the size of passing product. All such machines have in common a protective, light-admitting viewport for the sensor or sensors which protects the sensor or sensors from contamination from passing product.

Such sorting machines also include an ejector mechanism located downstream of the sensor or sensors and actuated by an electrical signal originating from sensor detection. When a product meeting selected criteria is detected, an electrical signal is produced to actuate the ejector as the selected product passes. The time elapsed between selected product passing the sensor or sensors and the selected product being ejected is minimal to limit possible vertical and/or horizontal deflection of the selected product upon contact with non-selected product or friction with the sorting machine channel. The ejector is therefore normally located as close as possible to the sensor or sensors, ideally being just downstream therefrom and closely adjacent thereto.

The ejector mechanism can be mechanical, but for small fungible products it is almost universally a compressed air ejector. When the selected product arrives opposite the ejector, the ejector emits a sharp expulsion or jet blast of air that impels the selected product from the product stream.

One consideration of the ejector mechanism is the need to suspend operation of the sorter based on surface contaminants from the passing product. Each time an air ejector expels a jet or blast of air, not only is substandard product ejected from the main product stream, but the surface of that product and other products that also contacted by the blast are “dusted”. Minute loose surface flakes or particulates are blown off or apart from the passing products settling wherever they are blown. These flakes or particulates are sometimes referred to collectively as “dust.” Most of this dust is harmlessly blown out of the main product flow with the ejected product, but much scatters in various other directions. The dust that settles on the viewport or viewports associated with the optical sensors creates the greatest obstacle. Over time this dust adheres to the light-admitting viewport or viewports for the sensor or sensors, causing the surface of the viewport or viewports to become progressively more opaque to the passage of light as the density and thickness of dust increases. Such viewport surface obstruction interferes with the sensitivity of discrimination detection necessary for proper sorting operation. At some time operation of the sorting machine must be suspended so the viewport or viewports may be sufficiently cleaned to permit proper operate. Obviously, it is desirable to minimize the amount of this suspension or “down time.”

Another consideration of the ejection is the need for the ejector to be properly located to effect complete ejection of the selected product. Should selected product not be directly before the ejector upon activation, the selected product may not be sufficiently impelled to effect separation and may be deflected within the product stream, potentially causing separation of unselected product or not causing separation of selected product. Typically the ejector is effectively sized for only one product size, thus limiting the utility of the sorter to specific products. Variation in size of product to be sorted also creates difficulties in efficient sorting. Product larger than that sized for ejection may not be deflected outside the product stream upon activation of the ejector. Particles smaller than that sized for ejection, including those not selected, may be deflected outside the product stream upon activation of the ejector.

Another consideration for the ejector mechanism is the associated size of the ejector and associated components. Ejector size limits the volume of product to be sorted during any unit time. Each ejector requires a width to accommodate it and potentially the controller necessary to effect ejection. As a result, and in connection with the channel and sizing requirements of the sort, the cumulative size of the ejectors may be significantly larger than the area of detection and deflection, thus requiring some locations not be subject to effective ejection.

Therefore, it is a feature of the present invention to provide sorting machine having a non-compressible-fluid-based ejector wherein the ejector may be effectively sized at any time or times to the fungible product being sorted to effect separation of a selected product from a flow of fungible products.

It is another feature of the present invention to provide an improved ejector for separating a selected product from a flow of fungible products passing through a sorting machine, the non-compressible-fluid-based ejector dispensing a deflecting coating minimizing the dust particles dispersed and to potentially accumulating on the sensor viewport.

It is another feature of the present invention to provide an improved ejector for separating a selected product from a flow of fungible products passing through a sorting machine, the non-compressible-fluid-based ejector employing a relatively-high viscosity high-adhesion fluid which will reduce the possibility of contamination of nearby product from diffusion and/or vaporization of the fluid into the surrounding atmosphere.

### SUMMARY OF THE INVENTION

The present invention pertains to an ejector for use in a sorting machine. Specifically the ejector is a non-air fluid-based ejector utilizing an actuator-port assembly. In the preferred embodiment such ejector has resolution of at least 20 dispersion ports per inch and likely no more than 250 dispersion ports per inch. Moreover in an alternative embodiment the ejector is activated to dispense fluid sized to the specific shape characteristics of the selected product. As a result of such port density, the ejector will be placed very close to the apparatus for identifying product to be ejected. In the preferred embodiment such distance is no more than 10 to 20 millimeters, to minimize product rotation about any axis which would alter specific share characteristics of the selected product. The ports actuated may be only those correlated to the outline of the product to be ejected or may be the entire exposed surface. Ideally the fluid is of sufficiently high viscosity and sufficiently high adhesion, such that the fluid does not significantly diffuse and/or vaporize through the surrounding atmosphere upon dispersion and adheres to the selected product upon contact.

The ejector may comprise a printhead, such as those associated with ink-jet printers.

### BRIEF DESCRIPTION OF THE DRAWINGS

So that the manner in which the described features, advantages and objects of the invention, as well as others which will become apparent, are attained and can be understood in detail, more particular description of the invention briefly summarized above may be had by reference to the embodiments thereof that are illustrated in the drawings, which drawings form a part of this specification. It is to be noted, however, that the appended drawings illustrate only typical preferred embodiments of the invention and are therefore not to be considered limiting of its scope as the invention may admit to other equally effective embodiments.

In the drawings:

FIG. 1 is front view of a typical multi-channel sorting machine for separating selected product from a stream of fungible products known in the prior art.

FIG. 2 is a side view of a typical multi-channel sorting machine for separating selected product from a stream of fungible products known in the prior art.

FIG. 3 is a side view of the ejector in question within the multi-channel sorting machine for separating selected product from a stream of fungible products known in the prior art.

FIG. 4 is a cross-sectional image of one port of the ejector.

FIG. 5 is an isometric view of a multiport ejector having a single-row dispensing head.

### DESCRIPTION OF THE PREFERRED EMBODIMENT

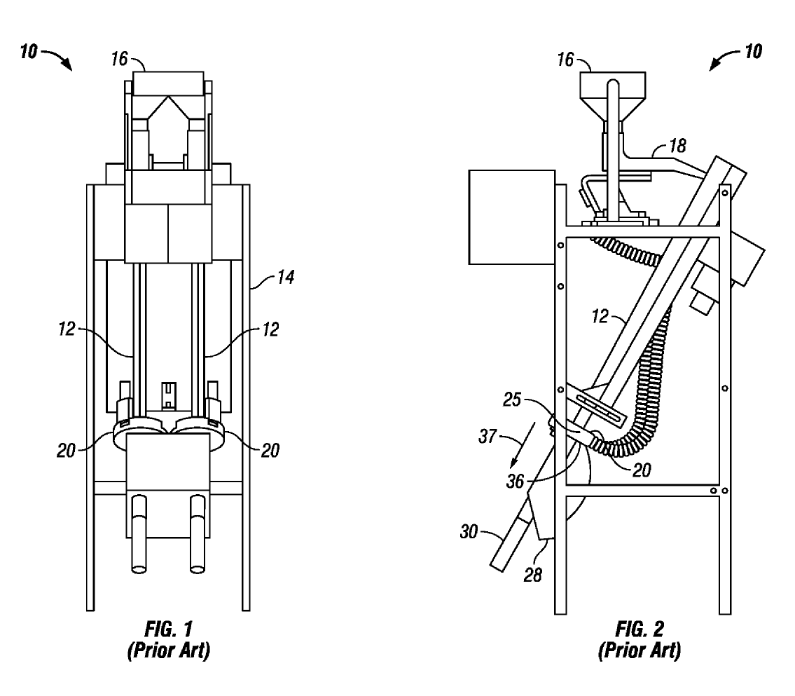

Now referring to the drawings and first to FIGS. 1 and 2, a multi-channel, high speed sorter for separating nonstandard fungible products from a passing stream or flow of such products and known in the art is shown. Generally, a typical sorting machine 10 includes one or more chutes or slides 12 at a steep angle, usually over 45 degrees from the horizon and preferably nearly vertical on the order of 80 degrees. The chutes are held in position by a framework 14. A hopper 16 containing product to be sorted is attached to the same framework and provides gravity feed of the product by respective chutes 18 to chutes 12. Product to be separated or sorted is any small fungible product or products, such as rice grains. Product flow rate is less than free fall due to friction between product and channel surface. As a result product flow rate is quite high, as is well-known in the art. Machines having only a single channel and machines with many more than two channels are not uncommon. For purposes of the invention, however, operation of a single channel only needs to be considered.

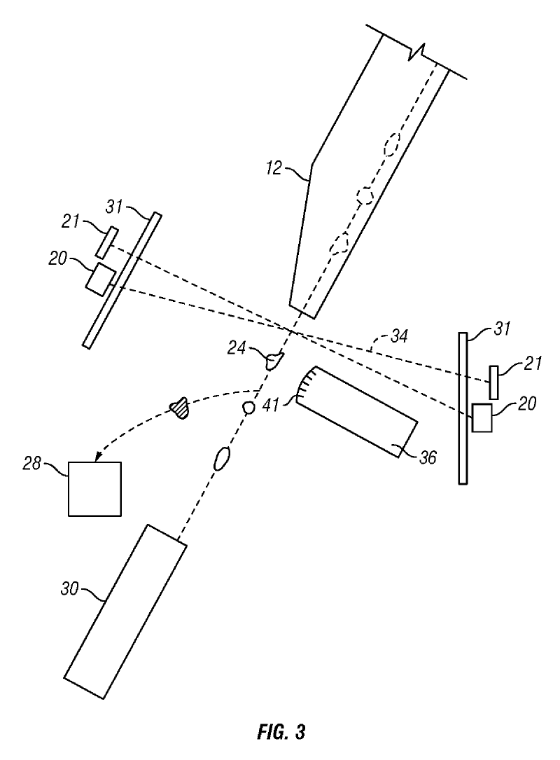

Referring to FIG. 3, one or more sensor 20, each having a scan line 13, are located toward the bottom of the machine such that the flow of product passes through the scan line 13 before an sensor 20 at which time any nonstandard, substandard, or otherwise selected products are sensed or detected. In the preferred embodiment a background 21 provides a background for detection, though optical viewers using a virtual background are known in the art. One fungible product to be sorted is rice. Typically, rice grains selected as “substandard” are those detected as darker than a predetermined quality degree of lightness. When such a substandard rice grain is sensed, an electrical signal is produced for ejection actuation purposes. Likewise identification of substandard rice grains may include parameters for the location and size of the selected product. Such considerations may be applied to any fungible product. In operation of such a sorting machine, sensor 20 may be configured to determine the velocity, namely speed and direction, of the selected product. It is therefore possible to identify the time and location at which the selected product will pass the ejector and, assuming minimal distance between sensor and ejector so as to minimize product rotation about any axis, the likely shape of the selected product normal to the ejector.

Scan line 13 is located on the flow of product passing through an opening close to, but just apart from, ports 34 of ejector 36.

The sensor 20 associated with scan line 13 is located opposite clear viewport 31 from the passing product such that light emission and reception are unimpeded.

Depending on the sensor or sensors selected, product discrimination may be made in whole or in part with respect to color or size. Further, specific bands of radiation, not necessarily within the visual spectrum, can be employed. Moreover the sensor 20 associated with scan line 13 may be an electronic photocamera, wherein the image may be pixilated for analysis. In any event, it will be evident that the viewport 31 allows proper operation to occur when it is clean, but operation deteriorates when it becomes opaque to light or other radiation emissions.

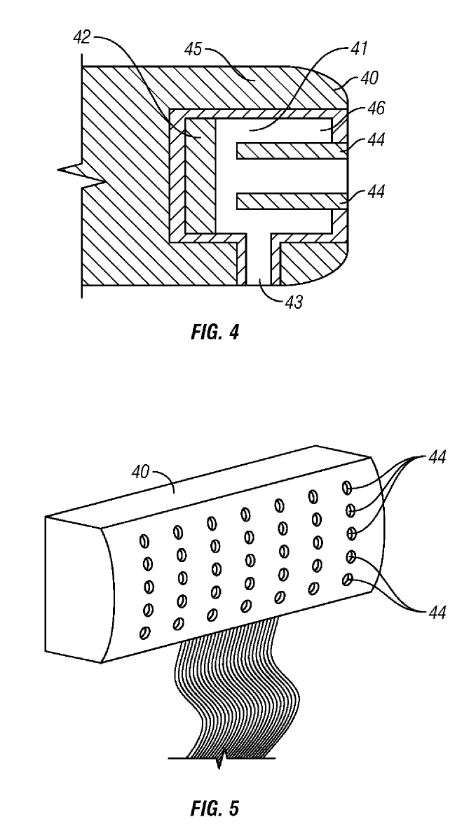

As is well known in the art, sensor 20 communicates images received to a computer 25, which compares the image received to predetermined criteria, which may be a floor, a ceiling or both, for retaining or ejecting product. An ejector 36 is located underneath and adjacent scan line 13. In the preferred embodiment ejector 36 is one or more dispensing heads 40, each dispensing head 40 having at least fifty (50) ports 45 per linear inch (ppi), although 20 ports per linear inch may suffice. As shown in FIG. 4, each port 45 of ejector 36 has a chamber 41 containing the non-air fluid 46. Each chamber 41 contains at least one piezoelectric crystal 42, each piezoelectric crystal 42 in communication with the computer 25. Each port 45 also includes at least one nozzle 44, which faces the passing product. Chamber 41 may be in fluid communication with a larger reservoir of non-air fluid through an orifice 43. Ideally, as shown in FIG. 5, in operation a matrix of dispensing heads 40 having one (1) or more rows aligned vertically is desired. However fewer rows may be used depending on the speed of the ports. One or more ports 45 are actuated by the actuation signal. Upon receipt of the activation signal, the piezoelectric crystal 42 will pulse, causing the non-air fluid contained within the chamber to be ejected through the nozzle 44 toward the product determined to be within or without the selected criteria. In the prior art such ejector has been a jet of air, activated by solenoid upon receipt of an electrical signal to activate, essentially a binary system (on/off). In a further alternative embodiment, the arrangement of ports 34 of ejector 36 may be constructed to correspond to pixilation received from an electronic photocamera sensor associated with scan line.

Unlike the binary ejection system known in the art, the present invention may utilize various ports of the ejector which may be matched to the selected product. Calculations based on data from scan line 13, namely selected product shape, location, and velocity permit identification of the time selected product will pass before ejector 36 and the approximate location at such time, as well as the boundary of the selected product at each unit of time during passage of the entire product before ejector 36. Utilizing such data, minute specific ports of ejector, rather than a number equivalent to the typical ejector size, are activated, corresponding with the shapeof selected product, including its outline, as it passes in front of the ejector. The delay in actuation is very short following sensing and, given the short distance between scan line 13 and ports 34 of ejector 36, prevents the selected product from significantly changing orientation or interacting with surrounding product. In the preferred embodiment one or more rows of ports are assembled to create an ejector matrix. In a further alternative embodiment, a zone of ports, within which product to be ejected will be present and larger than said product, may be simultaneously activated.

Alternatively a selection of ports may be activated over time to match the passing cross-section of selected product. An acceptable coating is thereby deposited only on selected product. The lateral force of one such deposit is sufficient to deflect selected product outside product stream. Alternatively, the lateral force of each application, associated with a pixel row of sensor 20, may cumulatively applied to the product be sufficient to deflect selected product outside product stream. The products thus removed in this process fall into accumulator 28. The products not removed continue down channel extension 30 to be gathered or packaged as products not having the characteristics selected for deflection, typically quality rather than substandard product. However it is envisioned that under certain circumstances it may be desirable to select rare product having superlative characteristics.

The control of the flow, the sensitivity of the sensors and the like are all controlled by preset controls, as is well-known in the art.

Use of an ejector matrix deflecting selected product by application of force solely to the selected product also minimizes “dust” being turbulently affected in the product stream, which potentially may cloud the viewport 31.

The use of a non-air fluid also provides improvement over the prior art, as air is more prone that liquid drops to diffusion or scattering after leaving the ejector. Thus less volume of ejecting fluid is required that would be required if air were used. Likewise adjacent product is less likely to be affected by each port activation.

Additionally, given the mapping of the shape of passing product scan line 13 of the sensor 20, it is also possible to print text and/or images on passing product.

The conveyance of the products has been discussed with respect to the illustrated overall system, the conveyance being the result of gravity feed from hopper 16. It is apparent that the products could be conveyed on a belt or by some other means, the invention not being limited by the manner in which product flow is achieved. Thus, it will be understood that while a preferred embodiment of the invention has been shown and described, the invention is not limited thereto. Many modifications may be made and will become apparent to those skilled in the art.

What is claimed is:

1. A multiport ejector for a machine for sorting product based on predetermined criteria, said sorting machine having:
(a) at least one product hopper;
(i) said at least one product hopper containing said product prior to sorting;
(b) at least one product transporter;
(i) said at least one product hopper communicating said product to said at least one product transporter;
(c) at least one product imager;
(d) at least one computer;
(i) said at least one computer receiving at least twenty product image signals per linear inch from said at least one product imager;
(e) said computer comparing each of said at least twenty product image signals per linear inch to said predetermined criteria;
(f) said computer transmitting at least one activation signal for each of said at least twenty product image signals for which the predetermined criteria is present;
(g) said multiport ejector proximate said at least one product imager;
(h) said multiport ejector aligned to said at least one product imager; said multiport ejector comprising:
(a) at least twenty liquid-containing chambers per linear inch;
(i) each of said at least twenty liquid-retaining chambers having at least one piezoelectric crystal therein;
(A) said at least one computer communicating with said at least one piezoelectric crystal in each of said at least twenty liquid-containing chambers;
(ii) each of said twenty liquid-containing chambers having at least one nozzle;
(A) each of said at least one nozzle directed to said product; and
(iii) said at least one piezoelectric crystal of at least one of said twenty liquid-containing chambers causing ejection of at least one drop of liquid through said at least one nozzle onto said product upon receipt of said activation signal.

2. A multiport ejector for a machine for sorting product based on predetermined criteria, said sorting machine having:
(a) at least one product hopper;
(i) said at least one product hopper containing said product prior to sorting;
(b) at least one product transporter;
(i) said at least one product hopper communicating said product to said at least one product transporter;
(c) at least one product imager, said at least product imager pixilating said product with a resolution of at least twenty pixels per linear inch, said at least one product imager transmitting the pixels to said computer;
(d) at least one computer;
(e) said computer comparing each of said pixels to said predetermined criteria, said computer comparing each of said pixels to a background to identify the edges of each of said product;
(f) said multiport ejector proximate said at least one product imager;
(g) said multiport ejector aligned to said at least one product imager; said multiport ejector comprising:
(a) at least twenty liquid-containing chambers per linear inch;
(i) each of said at least twenty liquid-retaining chambers having at least one piezoelectric crystal therein;
(A) said at least one computer communicating with said at least one piezoelectric crystal in each of said at least twenty liquid-containing chambers;
(ii) each of said twenty liquid-containing chambers having at least one nozzle;
(A) each of said at least one nozzle directed to said product; and
(iii) said at least one piezoelectric crystal of at least one of said twenty liquid-containing chambers causing ejection of at least one drop of liquid through said at least one nozzle onto said product upon receipt of said activation signal;
(b) said computer identifying at least one piezoelectric crystal to be activated, said computer transmitting an activation signal to said at least one piezoelectric crystal identified to be activated.

3. The multiport ejector of claim 2, wherein:
said identification of said at least one piezoelectric crystal identified to be activated being at least one piezoelectric crystal corresponding with said pixels identified by said computer as being the edge of said product for which the predetermined criteria is present.

4. The multiport ejector of claim 2, wherein:
said identification of said at least one piezoelectric crystal identified to be activated being at least one piezoelectric crystal corresponding with said pixels identified by said computer as being the perimeter of said product for which the predetermined criteria is present.

5. The multiport ejector of claim 2, wherein:
said identification of said at least one piezoelectric crystal identified to be activated being at least one piezoelectric crystal corresponding with said pixels identified by said computer as being the surface of said product for which the predetermined criteria is present.

6. The multiport ejector of claim 2, wherein: said identification of said at least one piezoelectric crystal identified to be activated being at least one piezoelectric crystal corresponding with said pixels identified by said computer as being the center of said product for which the predetermined criteria is present.

7. The multiport ejector of claim 2, wherein:
said identification of said at least one piezoelectric crystal identified to be activated being at least one piezoelectric crystal corresponding with said pixels identified by said computer as being the zone containing said product for which the predetermined criteria is present.
